(19) United States
(12) Patent Application Publication
(10) Pub. No.: US 2007/0243903 A1
(43) Pub. Date: Oct. 18, 2007

(54) Method of Selecting Retransmission Format in a Wireless Communication Multiple Antenna System

(75) Inventors: Bin Chul Ihm, Anyang-si (KR); Yong Suk Jin, Dongan-gu (KR); Jin Young Chun, Guro-gu (KR)

Correspondence Address: LEE, HONG, DEGERMAN, KANG & SCHMADEKA, 660 S. FIGUEROA STREET, Suite 2300, LOS ANGELES, CA, 90017, US

(73) Assignee: LG ELECTRONICS INC., Seoul (KR)

(21) Appl. No.: 11/576,248

(22) PCT Filed: Oct. 25, 2005
(86) PCT No.: PCT/KR05/03557

§ 371 Date: Mar. 28, 2007

(30) Foreign Application Priority Data
Oct. 25, 2004 (KR) 10-2004-0085455
Oct. 25, 2004 (KR) 10-2004-0085443

(51) Int. Cl. H04M 1/00

(52) U.S. Cl. 455/562.1

(57) ABSTRACT

A method of retransmitting a data packet in a wireless communication system having multiple antennas is disclosed. More specifically, a mobile station (MS) determines a retransmission format from a plurality of retransmission formats and then informs the determined retransmission format by which to retransmit the data packet.

$${A}_{1} = [ \begin{matrix}{\tilde{S}}_{1} & - & {\tilde{S}}_{2} & 0 & & 0 \\ {\tilde{S}}_{2} & & {\tilde{S}}_{1} & {\tilde{S}}_{3} & - & {\tilde{S}}_{4} \\ 0 & & 0 & {\tilde{S}}_{4} & & {\tilde{S}}_{5}\end{matrix} ]$$

$${A}_{2} = [ \begin{matrix}{\tilde{S}}_{1} & - & {\tilde{S}}_{2} & {\tilde{S}}_{3} & - & {\tilde{S}}_{4} \\ {\tilde{S}}_{2} & & {\tilde{S}}_{1} & 0 & & 0 \\ 0 & & 0 & {\tilde{S}}_{4} & & {\tilde{S}}_{5}\end{matrix} ]$$

$${A}_{3} = [ \begin{matrix}{\tilde{S}}_{1} & - & {\tilde{S}}_{2} & 0 & & 0 \\ {\tilde{S}}_{2} & & {\tilde{S}}_{1} & {\tilde{S}}_{3} & - & {\tilde{S}}_{4} \\ {\tilde{S}}_{2} & & {\tilde{S}}_{1} & {\tilde{S}}_{4} & & {\tilde{S}}_{5}\end{matrix} ]$$

### TECHNICAL FIELD

The present invention relates to a method of providing a base station with retransmission format information by which to retransmit a data packet, and more particularly, to a method of selecting retransmission format in a wireless communication multiple antenna system.

### BACKGROUND ART

In the recent years, the wireless communication system market has been growing rapidly and with such popularity, diverse multimedia services are demanded by the users. In order to keep pace with the increasing demand, in addition to large amount of data being transmitted but this large amount of data is expected to be transmitted fast.

Providing diverse multimedia service effectively means that the limited frequency resource has to be used efficiently. For this, one of the methods available is to use a multi-input, multi-output (MIMO) system.

Generally in the MIMO system, three to four antennas are used to transmit data (packet) using a spatial multiplexing (SM) scheme or a Space-Time Codes (STC) scheme. These schemes include diverse configurations of the data format received via each antenna.

As an example of the SM scheme, vector components of the data (or packet) transmitted via three transmission antennas can be presented according to the following equation.

$$[ \begin{matrix}{s}_{i + 1} \\ {s}_{i + 2} \\ {s}_{i + 3}\end{matrix} ] \qquad [ Equation 1 ]$$

If an error occurs during transmission of the packet, then the transmitting end modifies the packet (by changing the rows of the vector) transmitted via each transmission antenna and thereafter, retransmits the modified packet. The following equation is an example illustrating changing the rows of the vector. Here, the first antenna and the second antenna changes and swaps the previously transmitted packet before retransmitting.

$$[ \begin{matrix}- {s}_{i + 2}^{*} \\ {s}_{i + 2}^{*} \\ {s}_{i + 3}^{*}\end{matrix} ] \qquad [ Equation 2 ]$$

This type of retransmission scheme permits the first transmitted packet and the retransmitted packet attains Space Time Transmit Diversity (STTD) gain and in turn, allows the receiving end to attain higher signal-to-noise ratio (SNR) gain.

In addition to the SM scheme, the STC scheme can also use used. FIG. 1 illustrates an example of the STC matrix in the three-antenna system. In FIG. 1, a base station (BS) having multiple antennas uses the STC scheme to attain transmit diversity gain. The BS notifies a mobile station (MS) of the STC matrix selected or used by the BS in order to the MS to modulate the transmitted signals. In other words, the vector elements of the STC matrix are transmitted to the MS via each corresponding antenna.

After receiving the STC matrix, the MS uses the STC matrix to determine the BS transmitted signals according to each transmitting antenna, and based on the quality of the determined signal (channel status), a specific matrix can be selected from the STC matrix. As shown in FIG. 2, the MS can then use the MIMO-related feedback value to map the selected STC matrix on an uplink fasts feedback channel, also referred to as a Channel Quality Indication Channel (CQICH) to transmit to the BS.

Regardless which transmission scheme is employed to transmit data packet, there exists some problems. In particular, with respect to the packet retransmission method of the related art, two transmission packets initially transmitted by a pair of antenna groups each having two antennas are transmitted to achieve diversity gain. However, depending on the channel status, this type of fixed pair scheme does not always work in receiving the packets. For example, the signal from the third antenna of the retransmitted packet in the three-antenna system is simply retransmitted. Therefore, the third antenna signal would continue to experience deep fading. Furthermore, in transmitting or retransmitting, if the STC matrix is selected, the uplink fast feedback channel is used. As such, the feedback channel uses a slot comprised of 48 subcarriers which can be waste of resources if the subcarriers are not used to capacity.

### DISCLOSURE OF INVENTION

Accordingly, the present invention is directed to a method of selecting retransmission format in a wireless communication multiple antenna system that substantially obviates one or more problems due to limitations and disadvantages of the related art.

An object of the present invention is to provide a method of retransmitting a data packet in a wireless communication system having multiple antennas.

Another object of the present invention is to provide a method of retransmitting a data packet in a wireless communication system having at least three antennas.

A further object of the present invention is to provide a retransmitting format by which a base station (BS) can retransmit the data packet.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a method of retransmitting a data packet in a wireless communication system having multiple antennas includes a mobile station (MS) which determines a retransmission format from a plurality of retransmission formats and then informs the determined retransmission format by which to retransmit the data packet.

In another aspect of the present invention, a method of retransmitting a data packet in a wireless communication system having at least three antennas includes a mobile station (MS) which determines a retransmission format from a plurality of retransmission formats. Here, the retransmission format is determined by selection process based on a receiving scheme. Furthermore, the MS then informs the determined retransmission format by which to retransmit the data packet.

In another aspect of the present invention, a method of retransmitting a data packet in a wireless communication system having at least three antennas is introduced. In particular, a base station (BS) transmits a data packet to a mobile station (MS). Thereafter, the BS receives retransmission format information. Here, the retransmission format is determined by selection process based on a receiving scheme. Lastly, the BS retransmits the data packet according to the received retransmission format information if the BS receives Negative Acknowledgement (NACK) from the MS.

It is to be understood that both the foregoing general description and the following detailed description of the present invention are exemplary and explanatory and are intended to provide further explanation of the invention as claimed.

### BRIEF DESCRIPTION OF DRAWINGS

The accompanying drawings, which are included to provide a further understanding of the invention and are incorporated in and constitute a part of this application, illustrate embodiment(s) of the invention and together with the description serve to explain the principle of the invention. In the drawings;

FIG. 1 illustrates an example of the STC matrix in the three-antenna system;

FIG. 2 illustrates an example of the MS using the MIMO-related feedback value to map the selected STC matrix on an uplink fasts feedback channel;

FIG. 3 is an example of a channel matrix in a three-antenna system;

FIG. 4 illustrates an operation of the receiving end after receiving the transmitted signal;

FIG. 5 is an example illustrating three signal configuration options (A)-(C) retransmitting in the three-antenna system;

FIG. 6 illustrates an example of three signal configuration options (A)-(C) for retransmitting in a four-antenna system;

FIG. 7 is an example illustrating a vector matrix (X=MS+v) which combines a first signal with a second (or a retransmitted) signal;

FIG. 8 illustrates an example of the MS detecting the transmission signal of each antenna and selecting a preferable STC matrix; and

FIG. 9 is an example illustrating transmission via the CQICH using Tile(0), tile(1), Tile(2), Tile(3), Tile(4), and Tile(5) whereas the transmission via the ACK/NACK channel uses only Tile(1) and Tile(2).

### BEST MODE FOR CARRYING OUT INVENTION

Reference will now be made in detail to the preferred embodiments of the present invention, examples of which are illustrated in the accompanying drawings. Wherever possible, the same reference numbers will be used throughout the drawings to refer to the same or like parts.

Generally, in a three-antenna system, a transmitting end uses three antennas to transmit a packet (data), and a receiving end also employs three antennas to receive the signals transmitted from the transmitting end. FIG. 3 is an example of a channel matrix in a three-antenna system. In FIG. 3, the channel elements between the transmitting end and the receiving end are expressed as hᵢⱼ(i,j=1, . . . ,3). Then, the receiving signal (x₁(i)−x₃(i)) can be expressed as shown in FIG. 3. In FIG. 3, vᵢ₊₁−vᵢ₊₃ expresses an Additive White Gaussian Noise (AWGN).

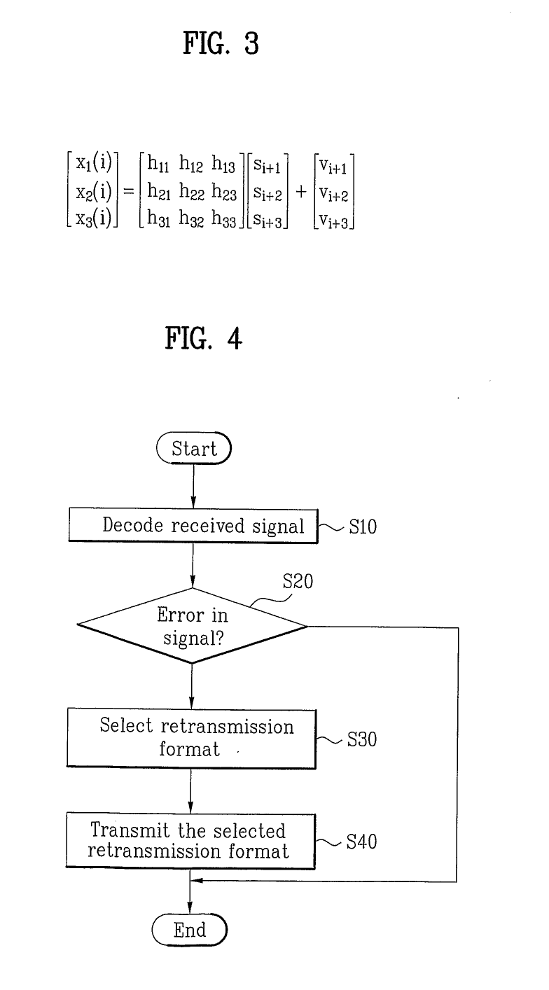

Furthermore, FIG. 4 illustrates an operation of the receiving end after receiving the transmitted signal. As illustrated in FIG. 4, the receiving end decodes the received signal to detect the data packet (S10). If the receiving end discovers error during the decoding operation (S11), the receiving end requests the transmitting end to retransmit the data packet. At this time, the receiving end uses an appropriate selection selected based on a receiving signal decoding method to select one retransmission format having an optimal SNR. In other words, the receiving end selects an antenna shuffling configuration and then transmits to the transmitting end (S12, S13).

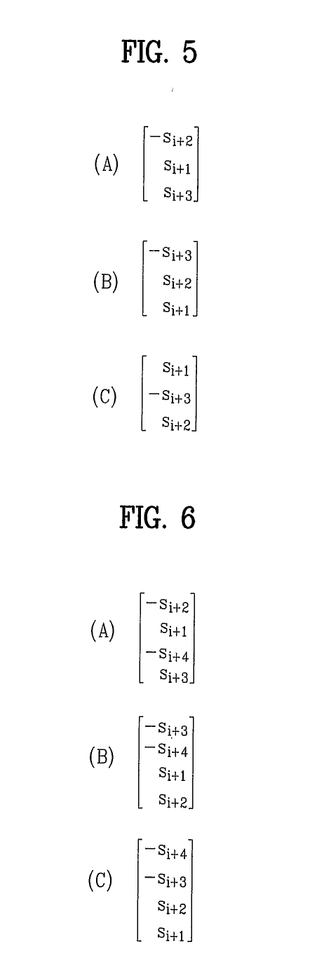

A more detailed description of the operation of the processes described in FIG. 4 will be provided. In the present invention, there are three retransmission formats, and each retransmission format comprises two sets of pair of antennas having the STTD configuration. FIG. 5 is an example illustrating three signal configuration options (A)-(C) retransmitting in the three-antenna system. With respect to options (A)-(C) of FIG. 3, when two antennas retransmit the data packet, each option rearranges the previous transmission signals while the remaining antenna transmits the initially transmitted signals.

Alternatively, FIG. 6 illustrates an example of three signal configuration options (A)-(C) for retransmitting in a four-antenna system.

In the present embodiment, which uses a communication system having at least three antennas, a decoding scheme such as Zero Forcing (ZF), a Minimum Mean Square Error (MMSE), and a V-BLAST can be used to select any one of options (A)-(C). Here, the principle behind selecting a signal decoding method is to choose an option corresponding to the best SNR.

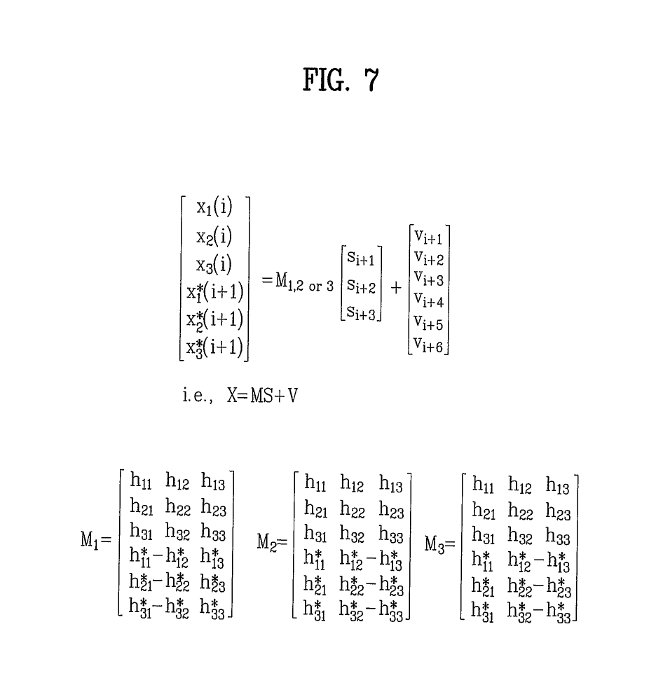

FIG. 7 is an example illustrating a vector matrix (X=MS+V) which combines a first signal with a second (or a retransmitted) signal. Here, X represents all initial and re-transmissions. If the receiving end uses the ZF scheme to decode signal S from the vector matrix, the decoded signal Ŝ can be expressed according to the following equation.
Ŝ=M⁺X [Equation 3]

In Equation 3, ‘+’ signifies pseudo-inverse. By applying M⁺ to each side of the vector matrix (X=MS+V) and thereafter apply Ŝ=M⁺X of Equation 3, Equation 4 can be acquired.
Ŝ=S+M⁺V [Equation 4]

Referring to Equation 4, the norm value or the magnitude of the noise variance (or noise power) M⁺ should be small in order for the SNR of the decoded signal Ŝ to be considered effective. Furthermore, in order for the magnitude of M⁺ to be small, the norm values (|M₁|²or|M₂|²or|M₃|²) of each row of M⁺(=M₁−M₃) also have to be small.

The receiving end first determines the norm value (| |²) of M⁺, which is an inverse matrix of the channel matrix. Because M⁺ is not a square matrix, the norm values take the form Mₖ⁺Mₖ⁺^{^{H}}(=PₖPₖ^{H}). That is, the norm value is generated from the product of the inverse matrix Pₖ of the channel matrix and the inverse matrix Pₖ of a Hermitian matrix.

Furthermore, the receiving end determines the smallest sum or product of Mₖ(k=1,2,3) from the diagonal element of the generated product vector (PₖPₖ^{H}). Thereafter, the receiving end provides the transmitting end of the option (k) corresponding to the determined smallest sum or product of Mₖ(k=1,2,3), as shown in Equation 5.

$$Option k = {arg min}_{k} Trace ( {P}_{k} {P}_{k}^{H} ) or \\ {arg min}_{k} Determinant ( diag ( {P}_{k} {P}_{k}^{H} ) ) \\ Here , {P}_{k} = {M}_{k}^{+} . \qquad [ Equation 5 ]$$

In another embodiment, the receiving end uses the MMSE scheme to decode signal Ŝ. Subsequently, the decoded signal Ŝ can be expressed according to Equation 7.
Ŝ=(αI+Mₖ^{H}Mₖ)⁻¹Mₖ^{H}X [Equation 7]

If (αI+Mₖ^{H}Mₖ)⁻¹Mₖ^{H} of Equation 7 is substituted with Pₖ and then organized in form of Equation 4, Equation 8 can be derived.
Ŝ=S+PₖV [Equation 8]

Furthermore, the decoded signal Ŝ is considered acceptable if the noise variance (power) Pₖ is small since smaller Pₖ means small SNR. As such, as illustrated in Equation 9 and same as in the ZF scheme, the receiving end determines the norm value of each row Pₖ. In other words, the receiving end determines the smallest sum or product Mₖ(k=1,2,3) of the diagonal element of product vectors (PₖPₖ^{H}) before transmitting the option (k) corresponding to the determined smallest sum or product to the transmitting end.

$$Option k = {arg min}_{k} Trace ( {P}_{k} {P}_{k}^{H} ) or \\ {arg min}_{k} Determinant ( diag ( {P}_{k} {P}_{k}^{H} ) ) \\ Here , {P}_{k} = {( α I + {M}_{k}^{H} {M}_{k} )}^{- 1} {M}_{k}^{H} and \\ \frac{1}{α} indicates the SNR . \qquad [ Equation 9 ]$$

In another embodiment of the present invention, the receiving end uses the V-BLAST scheme to retransmit the data packet. In the V-BLAST scheme, th e signal having the best SNR is decoded. The best SNR means that the noise variance (power) is the lowest from all the signals. Moreover, the lowest noise variance indicates highest reliance. Then the decoded signal is excluded while the remaining signals are decoded. Again, from the remaining signals, the signal having the best SNR or the lowest noise variance is decoded. This process is continued until all the signals are decoded. In short, the signal having the best SNR or the lowest noise variance is first decoded, followed by the signal having the next best SNR or the next lowest noise variance is decode while the first decoded signal is put aside until all the signals are decoded.

In operation, if the pseudo-inverse matrix of the channel matrix (M) is defined as Gi=Mₖ⁺(i=1), the receiving end determines the row having the smallest norm value from the rows of the Gᵢ matrix. For example, as shown in Equation 10, assume that row having the smallest norm value is mᵢ.

$${m}_{i} = {arg min}_{j ∉ ( {m}_{1} , {m}_{2} , … , {m}_{i - 1} )} {‖ {( {G}_{k , i} )}_{j} ‖}^{2} \qquad [ Equation 10 ]$$

In Equation 10, because (G)ⱼ indicates jth row of the G matrix, the norm value mᵢ th row of the G matrix is ∥(G_{k,i})ₘ_{ᵢ}∥² and the norm value can be expressed as qₖⱼ.

First, if the value of the row mᵢ having the smallest vector norm is determined, the receiving end acquires G_{k,i+1}(i=i+1) of the pseudo-inverse matrix to decoded the next transmitted signal. The value G_{k,i+1} can be acquired by eliminating the column corresponding to mᵢ (mᵢ th column) That is, the pseudo-inverse matrix without the mᵢ th column (all mᵢ th columns are zero) can be expressed according to Equation 11.

$${G}_{k , i + 1} = {M}_{k} \frac{+}{m} , where i = i + 1 \qquad [ Equation 11 ]$$

From Equation 11,

$${( M )}_{\overline{m}}$$

indicates matrix M without m₁,m₂, . . . ,mᵢ columns.

Then, the receiving end determines the smallest vector norm from the rows of G_{k,i+1} and value of the smallest vector norm. Furthermore, the receiving end repeatedly executes column elimination process, as described above, to acquire the norm value of the pseudo-inverse matrix (G).

In Equation 12, the receiving end determines Mₖ having the smallest norm sum or norm product and transmits the option (k) which corresponds to the determined Mₖ.

$$Option k = {arg min}_{k} {\sum }_{i = 1}^{\# ofcolumns} {q}_{k , i} \\ or {arg min}_{k} {\prod }_{i = 1}^{\# ofcolumns} {q}_{k , i} \qquad [ Equation 12 ]$$

Furthermore, the transmitting end uses the retransmission format which corresponds to the option (k), which was selected from one of the three retransmission formats, to retransmit the data packet.

A criteria by which the V-BLAST scheme is applied is not limited to the signal having the best SNR. In practice, the minimizing operation of the V-BLAST scheme can be applied not only to a sum or a product of a norm having the best SNR or the lowest noise variance. This scheme can be applied to minimize the lowest norm values. At the same time, the same scheme can be applied to minimize the highest norm values.

For example, in a three-antenna system, there are three norm values mᵢ per each matrix Mₖ(M₁, M₂, and M₃). From each matrix, there is a norm value having the lowest noise variance (A₁ of M₁, C₂ of M₂, and B₃ of M₃), and at the same time, a norm value having the highest noise variance (A₂ of M₁, C₃ of M₂, and B₁ of M₃). From these values, as discussed above, a product or a sum of the norm values can be minimized. That is, min{(A₁+B₁+C₁),(A₂+B₂+C₂),(A₃+B₃+C₃)} and min{(A₁B₁C₁),(A₂B₂C₂),(A₃B₃C₃)}. Furthermore, the norm values having the lowest noise variance from each matrix can be selected for minimization. That is, min{A₁,C₂,B₃} can be performed to acquire the lowest noise variance (power) from a batch of norm values having the lowest noise variances. Alternatively, the norm values having the highest noise variance from each matrix can be selected for minimization. That is, min{A₂,C₃,B₁} can be performed to acquire the lowest noise variance (power) from a batch of norm values having the highest noise variances. As indicated here, the criteria by which the minimizing operation can be applied to is expansive and not limited to a product or a sum of the specified norm values.

Alternatively, at the BS, the retransmission format by which to retransmit the data packet determined by the MS is received. Thereafter, the receiving end transmits the data packet accordingly and at the same time, transmits a confirmation signal to allow the MS to know what format was used to retransmit the data packet. Such a confirmation signal is helpful in case the BS did not transmit the data packet as requested by the MS. For example, if the BS transmits the data packet differently from the provided retransmission format, with the confirmation signal of which retransmission format was used to retransmit the data packet, the MS can decode accordingly, even if unexpected retransmission format was used.

In another embodiment of the present invention, the embodiment relates to selection and transmission of the STC matrix used by the BS in the three-antenna system. In the embodiment, the MIMO-related feedback value or the STC matrix selected value is fed back not via the uplink fast feedback channel, but an Acknowledgment/Negative Acknowledgment (ACK/NACK) channel.

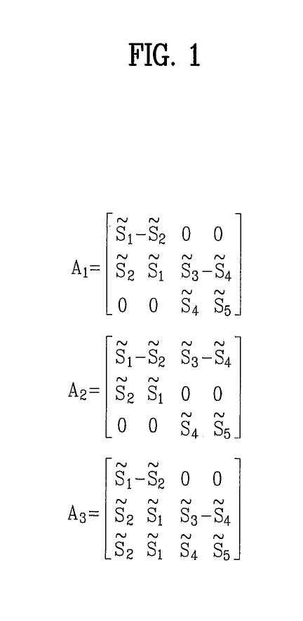

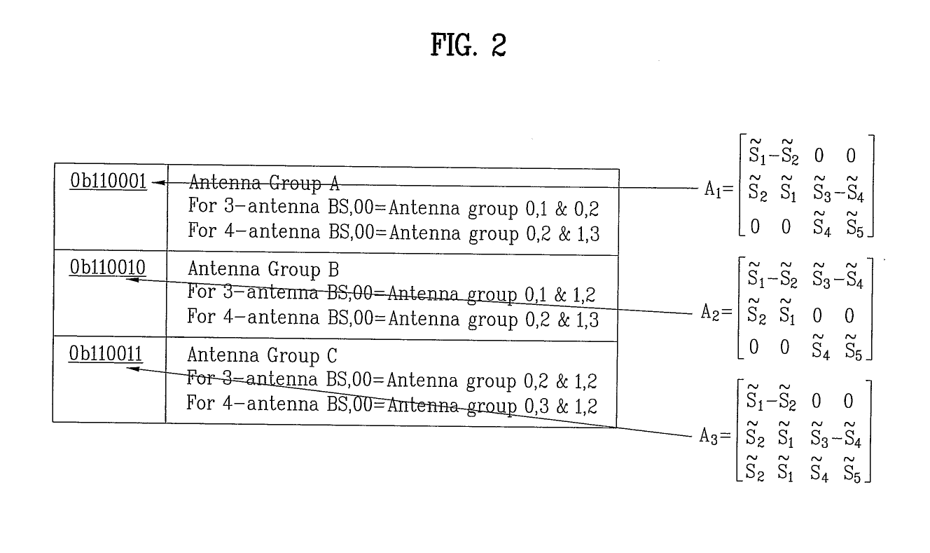

In operation, the BS having multiple antennas selects a STC matrix from the STC matrix shown in FIG. 1 and notifies the selected STC matrix to the MS. As illustrated in FIG. 8, the MS detects the transmission signal of each antenna and selects a preferable STC matrix. The preferred STC matrix is then transmitted as feedback to the BS via the ACK/NACK channel (S10-S12).

By using the ACK/NACK channel, the subcarriers used in transmission is reduced in half. In other words, the CQICH uses a slot comprising 48 subcarriers to transmit the selected STC matrix, but the ACK/NACK channel uses a slot comprising 24 subcarriers to transmit the selected STC matrix.

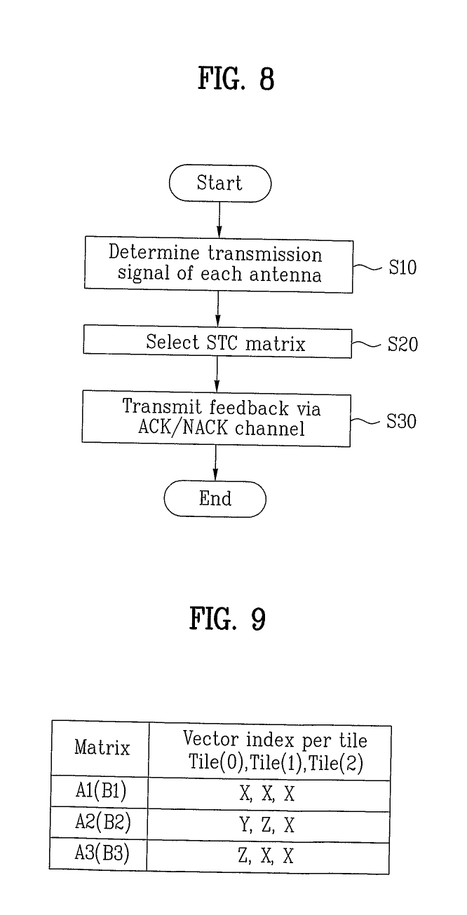

Furthermore, as illustrated in FIG. 9, the transmission via the CQICH uses Tile(0), tile(1), Tile(2), Tile(3), Tile(4), and Tile(5); however, the transmission via the ACK/NACK channel uses only Tile(1) and Tile(2). Accordingly, the BS transmits or retransmits the data to the MS according to the STC matrix, which was fed back to the MS.

### INDUSTRIAL APPLICABILITY

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

1. A method of retransmitting a data packet in a wireless communication system having multiple antennas, the method comprising:
determining a retransmission format from a plurality of retransmission formats; and
informing the determined retransmission format by which to retransmit the data packet.

2. The method of claim 1, wherein the multiple antennas is at least three antennas.

3. The method of claim 1, wherein the retransmission format is different from an initial transmission format.

4. The method of claim 3, wherein at least two signals of the retransmission format use different antennas than antennas used by the at least two signals of the initial transmission format.

5. The method of claim 1, wherein the retransmission format is determined by selection process based on a receiving scheme.

6. The method of claim 5, wherein the receiving scheme is a Zero Forcing (ZF), Minimum a Means Square Error (MMSE), or a Vertical Bell Laboratory Layered Space-Time (V-BLAST).

7. The method of claim 5, wherein the selection process includes generating a channel matrix corresponding to each retransmission format.

8. The method of claim 7, wherein the selection process further includes taking inverse of the each channel matrix using the ZF scheme, the MMSE scheme, or the V-BLAST scheme.

9. The method of claim 8, wherein the selection process further includes selecting a retransmission format having a smallest criteria value from the inversed channel matrices.

10. The method of claim 9, wherein the criteria value includes a sum or a product of norms of every rows of the inversed channel matrix.

11. The method of claim 9, wherein the criteria value includes maximum or minimum norms of every rows of the inversed channel matrix.

12. The method of claim 1, wherein the plurality of retransmission formats includes different arrangements of signals, and wherein the arrangements of signals of the retransmission formats are different from the arrangement of signals of an initial transmission format.

13. The method of claim 12, wherein the retransmission format includes a Space-Time Transmit Diversity (STTD).

14. The method of claim 1, wherein the determined retransmission format is transmitted via an Acknowledgement/Negative Acknowledgement (ACK/NACK) channel.

15. The method of claim 1, wherein the determined retransmission format is transmitted via a Medium Access Channel (MAC) header, data traffic, or a Channel Quality Indication Channel (CQICH).

16. A method of retransmitting a data packet in a wireless communication system having at least three antennas, the method comprising:
determining a retransmission format from a plurality of retransmission formats, wherein the retransmission format is determined by selection process based on a receiving scheme; and
informing the determined retransmission format by which to retransmit the data packet.

17. The method of claim 16, wherein the retransmission format is different from an initial transmission format.

18. The method of claim 17, wherein at least two signals of the retransmission format use different antennas than antennas used by the at least two signals of the initial transmission format.

19. The method of claim 1, wherein the receiving scheme is a Zero Forcing (ZF), Minimum a Means Square Error (MMSE), or a Vertical Bell Laboratory Layered Space-Time (V-BLAST).

20. The method of claim 19, wherein the selection process includes generating channel matrices according to each retransmission format.

21. The method of claim 20, wherein the selection process further includes taking inverse of the each channel matrix using the ZF scheme, the MMSE scheme, or the V-BLAST scheme.

22. The method of claim 21, wherein the selection process further includes selecting a best retransmission format having a smallest criteria value from the inversed channel matrices.

23. The method of claim 21, wherein the criteria value includes a sum or a product of norms of every rows of the inversed channel matrix.

24. The method of claim 21, wherein the criteria value includes maximum or minimum norms of every rows of the inversed channel matrix.

25. The method of claim 16, wherein the plurality of retransmission formats includes different arrangements of signals, and wherein the arrangements of signals of the retransmission formats are different from the arrangement of signals of an initial transmission format.

26. The method of claim 16, wherein the determined retransmission format is transmitted via an Acknowledgement/Negative Acknowledgement (ACK/NACK) channel.

27. A method of retransmitting a data packet in a wireless communication system having at least three antennas, the method comprising:
transmitting a data packet to a mobile station (MS);
receiving retransmission format information, wherein the retransmission format is determined by selection process based on a receiving scheme; and
retransmitting the data packet according to the received retransmission format information if a bases station (BS) receives Negative Acknowledgement (NACK) from the MS.

28. The method of claim 27, further comprising transmitting a confirmation signal which indicates the retransmission format transmitted by the BS.
